(19) United States
(12) Patent Application Publication
(10) Pub. No.: US 2006/0291924 A1
(43) Pub. Date: Dec. 28, 2006

(54) Fusing unit and fusing apparatus using the same

(75) Inventors: Jae-hyeuk Jeong, Suwon-si (KR); Dong-kyun Kang, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/393,798

(22) Filed: Mar. 31, 2006

(30) Foreign Application Priority Data
Jun. 23, 2005 (KR) 10-2005-0054386

(51) Int. Cl. G03G 15/20

(52) U.S. Cl. 399/333

(57) ABSTRACT

A fusing unit and a fusing apparatus using the fusing unit are provided. The fusing unit includes a pipe-shaped fusing roller, an internal pipe inserted into an inner portion of the fusing roller, a heating unit disposed between the fusing roller and the internal pipe to surround the internal pipe and generate heat, and an insulating portion having a first insulating portion disposed between the heating unit and the fusing roller and a second insulating portion disposed between the heating unit and the internal pipe. The first insulating portion has a higher thermal conductivity than the second insulating portion.

### CROSS-REFERENCE TO RELATED PATENT APPLICATION

This application claims the benefit under 35 U.S.C. § 119(a) of Korean Patent Application No. 10-2005-0054386, filed on Jun. 23, 2005, in the Korean Intellectual Property Office, the disclosure of which is incorporated herein in its entirety by reference.

### BACKGROUND OF THE INVENTION

1. Field of the Invention

The present invention relates to an image forming apparatus. More particularly, the present invention relates to a fusing unit of an image forming apparatus for fusing a toner image on a paper by applying heat and pressure.

2. Description of Related Art

In general, an electrophotographic color image forming apparatus forms a color image by irradiating light on a photosensitive medium charged with a predetermined electric potential to form an electrostatic latent image, developing the electrostatic latent image with predetermined color toners, and transferring and fusing the developed image on a paper.

FIG. 1 is a transverse cross sectional view schematically showing a fusing unit of a conventional fusing apparatus where a halogen lamp is used as a heat source, and FIG. 2 is a longitudinal cross sectional view showing a relation between the fusing unit and a pressing roller shown in FIG. 1.

Referring to FIG. 1, a fusing unit 10 applies heat to a toner image and includes a pipe-shaped cylindrical fusing roller 11 and a heat generating unit 12 provided inside the fusing roller 11 to generate heat by using current transmitted from an external power supply (not shown). A release layer 11a made of an elastic material to improve the release of the toner image is provided on a circumferential surface of the heat generating unit 12.

The heat generating unit 12 generates radiant energy (heat) which is transmitted to the fusing roller 11 through air in an inner portion of the fusing roller 11. The radiant energy is converted to thermal energy by an opto-thermal conversion layer (not shown) coated on an inside surface of the fusing roller 11 to heat the fusing roller 11, and then, the release layer 11a is heated to a predetermined fusing temperature by thermal conduction.

Referring to FIG. 2, a pressing roller 13 is disposed under the fusing unit 10. The pressing roller 13 is elastically supported by a spring member 13a so as to press the paper 14 passing between the fusing unit 10 and the pressing roller 13 toward the fusing unit 10.

At this time, the powder toner image 14a formed on the paper 14 is pressed and heated with predetermined pressure and heat while the paper 14 passes between the fusing unit 10 and the pressing roller 13. That is, the toner image 14a is fused on the paper 14 with predetermined temperature heat and pressure by the fusing unit 10 and the pressing roller 13.

Since the conventional fusing apparatus using the halogen lamp as a heat source consumes a large amount of electric power, the power must be cut off when there is no printing operation.

Further, when turned on for a printing operation, the conventional fusing apparatus requires a relatively long warn-up time until the apparatus reaches a fusing temperature.

The time between the time when the fusing apparatus is turned on until the fusing apparatus reaches a desired fusing temperature is called a first-print-out-time (hereinafter, referred to as FPOT). In some cases, the FPOT of a conventional fusing apparatus may be tens of seconds or several minutes.

In particular, since the fusing roller of the conventional fusing apparatus is heated with the radiant energy transmitted from the heat source, the heat transmission rate is slow. Further, since heat is transmitted from the fusing roller to the paper by conduction (that is, the contact of the fusing roller to the paper), the compensation for temperature variation is slow when the temperature decreases. Accordingly, it is difficult to control temperature distribution on the fusing roller.

In addition, since electric power is applied to the heat source in a constant period in order to maintain the temperature of the fusing roller 11 at a constant value even when the printer is in a standby mode which is an idle state of printing operation, there is a problem in that unnecessary electric power is consumed. In addition, since a relatively large amount of time is required to change from a standby mode into an operating mode, there is another problem in that rapid image output cannot be achieved.

Accordingly, there is a need for an improved fusing apparatus for an image forming apparatus that consumes less power than conventional fusing apparatus, and that reaches a fusing temperature in a shorter time than a conventional fusing apparatus.

### SUMMARY OF THE INVENTION

An aspect of the present invention is to address at least the above problems and/or disadvantages and to provide at least the advantages described below. Accordingly, an aspect of the present invention is to provide a fusing apparatus of an image forming apparatus that consumes low current and electric power, that increases the temperature of a fusing roller to a fusing temperature in a short time, and that has a high dielectric strength.

In accordance with an aspect of the present invention, a fusing unit comprises a pipe-shaped fusing roller, an internal pipe inserted into an inner portion of the fusing roller, a heating unit disposed between the fusing roller and the internal pipe to surround the internal pipe and generate heat, and an insulating portion having a first insulating portion disposed between the heating unit and the fusing roller and a second insulating portion disposed between the heating unit and the internal pipe, wherein the first insulating portion has a higher thermal conductivity than the second insulating portion.

In accordance with another aspect of the present invention, a method of manufacturing a fusing roller comprises the steps of surrounding an internal pipe with a second insulating portion, surrounding the second insulating portion with a heating unit, surrounding the heating unit with a first insulating portion, inserting the internal pipe with the second insulating portion, the heating unit, and the first insulating portion into a fusing roller, and expanding the internal pipe into engagement with the fusing roller.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a transverse sectional view schematically showing a fusing unit of a conventional fusing apparatus where a halogen lamp is used as a heat source;

FIG. 2 is a longitudinal sectional view of a pressing roller and the fusing unit shown in FIG. 1;

FIG. 3 is a longitudinal sectional view of a fusing apparatus of an image forming apparatus according to an exemplary embodiment of the present invention;

FIG. 4 is a transverse sectional view of a fusing unit of an image forming apparatus according to a first exemplary embodiment of the present invention;

FIG. 5 is a partial enlarged view of the portion C shown in FIG. 4;

FIG. 6 is a partial enlarged view of a portion of a fusing unit according to a second exemplary embodiment of the present invention; and

FIG. 7 is a partial enlarged view of a portion of a fusing unit according to a third exemplary embodiment of the present invention.

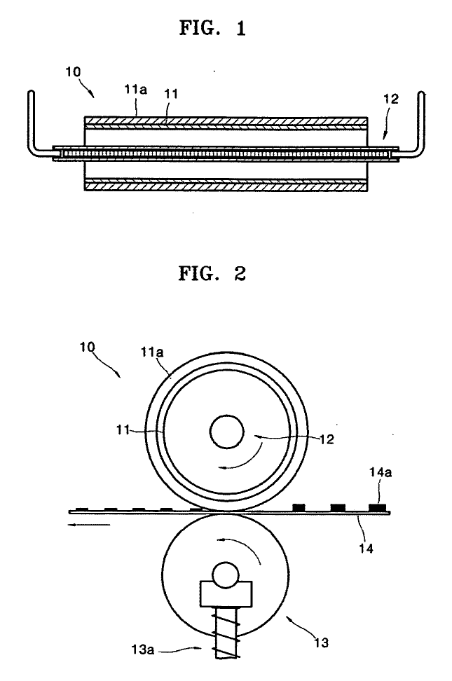

Throughout the drawings, the same reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

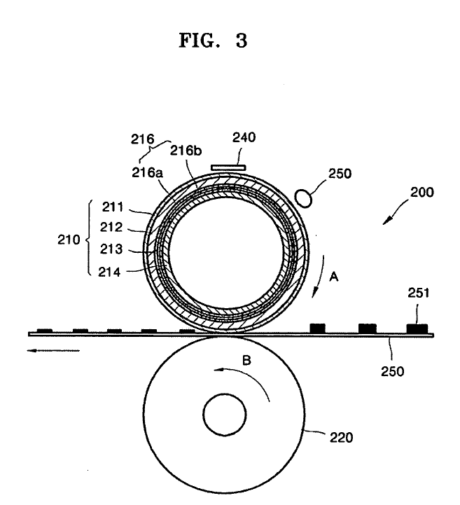

Referring to FIGS. 3 to 5, a fusing apparatus 200 is an apparatus for fusing a toner image 251 on a paper 250 by applying heat and pressure to the toner image 251. The fusing apparatus 200 includes a fusing unit 210 for applying heat to the toner image 251 while rotating in the direction of the arrow A and a pressing roller 220 that faces the fusing unit 210 to press the toner image 251 toward the fusing unit 210 while rotating in the direction of the arrow B.

The fusing unit 210 includes a pipe-shaped fusing roller 212 which is coated with a surface release layer 211 of polytetrafluoroethylene (PTFE) or the like. An open-ended pipe-shaped internal pipe 214 is inserted into an inner portion of the fusing roller 212, and a heating unit 213 is disposed between the fusing roller 212 and the internal pipe 214 and surrounds a circumferential surface of the internal pipe 214 in a spiral shape to generate heat with current supplied from an external power supply (not shown). An insulating portion 216 surrounds the heating unit 213 to insulate the internal pipe 214 from the fusing roller 212 so as to prevent dielectric breakdown and current leakage when current is applied to the heating unit 213.

The fusing roller 212 and the internal pipe 214 may be made of stainless steel, aluminum (Al), copper (Cu), or the like.

The heating unit 213 is constructed with resistance heat generating coils for generating heat with current supplied from the external power supply (not shown). Lead portions 213a extend from both ends of the heating unit 213 to receive current from the external power supply.

The insulating portion 216 includes a first insulating portion 216a disposed between the fusing roller 212 and the heating unit 213 and a second insulating portion 216b disposed between the heating unit 213 and the internal pipe 214.

The first insulating portion 216a may be made of, for example, polyimide, and the second insulating portion 216b may be constructed by, for example, overlapping two mica sheets.

The insulating portion 216 transmits heat generated by the heating unit 213. The insulating portion 216 should also have certain characteristics, such as a withstand voltage characteristic, and a resistance to dielectric breakdown characteristic. When taking the characteristic of resistance to dielectric breakdown into consideration, the first insulating layer 216a may have, for example, a thickness of 0.02 to 0.04 mm and each mica sheet of the second insulating portion 216b may have, for example, a thickness of 0.15 mm. Therefore, the thickness of the first insulating portion 216a may be smaller than that of the second insulating portion 216b.

Here, the withstand voltage characteristic denotes a characteristic of withstanding an applied predetermined external electric power, and the characteristic of resistance to dielectric breakdown denotes a characteristic of not generating a leakage current of 10 mA or more without dielectric breakdown for one minute under a maximum withstand voltage of 3 kV. Each insulating portion should overcome an applied withstand voltage of 3 kV in order to satisfy Canadian withstand voltage specifications defined by CSA (Canadian Standards Association) and European withstand voltage specifications.

TABLE 1

| | mica | PI | LCP |
|---|---|---|---|
| Thermal | 0.25˜0.5 | 0.3˜1.7 | 0.5˜0.7 |
| Conductivity | | | |
| W/m° C. | | | |
| Dielectric | 20˜200 | 800˜1700 | 500˜1500 |
| Strength kV/cm | | | |

Table 1 shows the thermal conductivities and dielectric strengths of mica, Polyimide (PI), and Liquid crystalline polymer (LCP).

By comparing the thermal conductivities of the mica and the PI, it can be seen that the maximum thermal conductivity of the PI is about three times higher than the maximum thermal conductivity of mica. Therefore, it can be understood that a larger amount of the radiant heat (energy) generated by the heating unit 213 is transmitted to the first insulating portion 216a made of PI than to the second insulating portion 216b made of mica. As a result, a large amount of the heat generated by the heat unit 213 is transmitted through the first insulating portion 216a to the fusing roller 212, so that the surface temperature of the fusing roller 212 can increase up to a fusing temperature.

In addition, since the thickness of the first insulating portion 216a is smaller than that of the second insulating portion 216b, heat can be rapidly transmitted.

Referring to FIG. 6, a first insulating portion 316a may be made of, for example, a liquid crystal polymer (hereinafter, referred to as LCP), and a second insulating portion 316b may be constructed by overlapping two mica sheets.

The insulating portion 316 transmits heat generated by the heating unit 213. The insulating portion 216 should also have certain characteristics, such as a withstand voltage characteristic, and a resistance to dielectric breakdown characteristic. When taking the characteristic of resistance to dielectric breakdown into consideration, the first insulating layer 316a may have a thickness of, for example, 0.045 to 0.07 mm and each mica sheet of the second insulating portion 316b may have a thickness of, for example, 0.15 mm. Therefore, the thickness of the first insulating portion 316a is smaller than that of the second insulating portion 316b.

Like the previous embodiment, the withstand voltage characteristic should meet CSA and European withstand voltage specifications.

By comparing the thermal conductivities of the LCP and the mica, it can be seen that the thermal conductivity of the LCP is higher than that of the mica. Therefore, a larger amount of the radiant heat (energy) generated by the heating unit 213 is transmitted to the first insulating portion 316a made of LCP than to the second insulating portion 316b made of mica. As a result, most the heat generated by the heat unit 213 is transmitted through the first insulating portion 316a to the fusing roller 212, so that the surface temperature of the fusing roller 212 can increase up to a fusing temperature.

The thermal conductivity of the LCP is smaller than the thermal conductivity of the PI. Therefore, assuming that the thermal conductivities should be equal to each other, the thickness of the first insulating portion 316a made of LCP is larger than that of the first insulating portion 216a made of PI.

The LCP material has certain advantages, such as excellent thermal resistance and electrical stability in a high frequency range. Further, since the LCP is a thermoplastic material, the LCP itself has certain adhesive characteristics, so that the LCP is more useful for an adhesive effect than existing insulating materials.

The thicknesses of the LCP and the PI may be 100 μm or less.

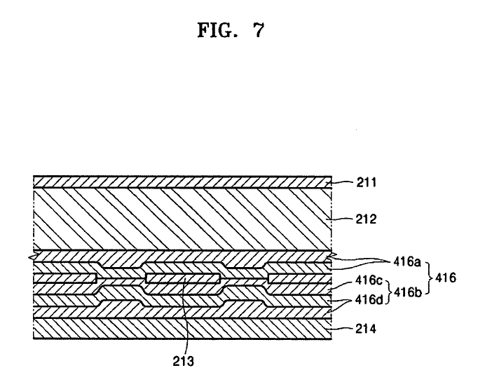

Referring to FIG. 7, a first insulating portion 416a may be constructed with two mica sheets 2, and a second insulating portion 416b may be constructed by overlapping a heat shielding portion 416c and two mica sheets 416d.

The heat shielding portion 416c may be made of plaster or ceramic having a high porosity and a low thermal conductivity or a glass-filled heat-resistance polymer material having a low thermal conductivity. In addition, the thickness of each of the heat shielding portion 416c and a single mica sheet may be, for example, 0.15 mm.

The transmission of the radiant energy (heat) generated by the heating unit 213 to the internal pipe 214 is shielded by the heat shielding portion 416c, so that the heat can be transmitted through the first insulating portion 416a to the fusing roller 212.

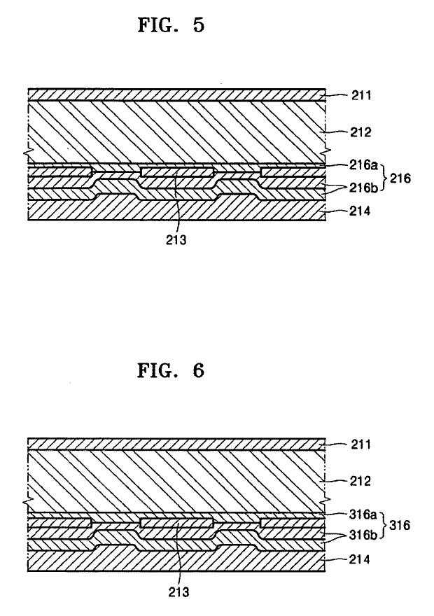

On the other hand, the thickness of the first insulating layer 416a is larger than those of the first insulating portion 216a made of PI shown in FIG. 5 and the second insulating portion 316a made of LCP shown in FIG. 6.

In this manner, different thermal conduction efficiencies are provided by using materials having different thermal conductivities, so that the direction of heat transmission can be controlled.

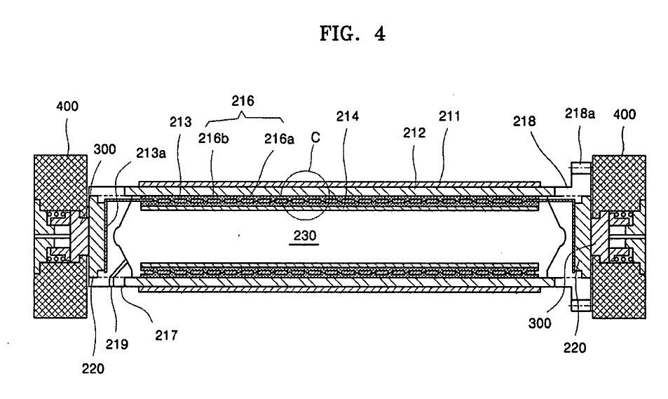

Referring to FIGS. 3 and 4, an end cap 217 and a power transmission end cap 218 are disposed at both ends of the fusing roller 210, respectively. The construction of the power transmission end cap 218 is similar to that of the end cap 217, but the power transmission end cap 218 is provided with power transmission means 218a such as gears which is connected to a motor unit (now shown) disposed on a frame 400 supporting the fusing roller 210 to rotate the fusing roller 210.

An air vent 219 is formed on the end cap 217. The air vent 219 allows external air to flow into an internal space 230 of the fusing roller 210 after the end cap 217 is installed in the fusing roller 210, so that the internal space 230 of the fusing roller 210 can be maintained at the atmospheric pressure.

Therefore, although the internal pipe 21 is heated with heat transmitted from the heating unit 213, the internal space 230 can be maintained at atmospheric pressure due to the external air flowing through the air vent 219. Alternatively, the air vent 219 may be provided to the power transmission end cap 218, or the air vent 219 may be provided to both of the end cap 217 and the power transmission end cap 218.

Electrodes 220 are provided to the end cap 217 and power transmission end cap 218. The electrodes 220 are electrically connected to the lead portions 213a. Current supplied by the external power supply is applied to the heating unit 213 through the power supply unit 300, the electrodes 220, and the lead portions 213a.

A thermostat 240 for blocking power supply to prevent overheating if the surface temperature of the release layer 211 rapidly increases and a thermistor 250 for measuring the surface temperatures of the fusing roller and the release layer 211 are disposed over the fusing unit 210.

A method of manufacturing the fusing unit 210 will now be described.

The circumferential surface of the internal pipe 214 is surrounded with the second insulating portion 216b. The heating unit 213 is disposed in a spiral shape so as to surround the second insulating portion 216b. Next, the first insulating portion 216a is disposed so as to surround the heating unit 213.

The internal pipe 214 provided with the heating unit 213, the first insulating portion 216a, and second insulating portion 216b is inserted into an inner portion of the fusing roller 212. The circumferential surface of the fusing roller 212 is coated with a release layer such as polytetrafluoroethylene (PTFE) or the like.

Next, by using an apparatus for enlarging the internal pipe 214, both ends of the internal pipe 214 are blocked, and a predetermined pressure is applied to the internal space 230 of the internal pipe 214 so that the internal pipe 214 expands. To expand the pipe, the pressure may be 140 atmospheres or more.

The internal pipe 214 is expanded, the fusing roller 212 is maintained in a shape of circle, and the heating unit 213 and the insulating portion 216 are subjected to plastic deformation.

Therefore, the heating unit 213, the internal pipe 214, the first insulating portion 216a, and the second insulating portion 216b adhere to the fusing roller 212.

Namely, as shown in FIG. 5, since the heating unit 213 is constructed with resistance heat generating coils, the spaces between adjacent coils are filled with the first and second insulating portions 216a and 216b to adhere to the fusing roller 212 when the internal pipe 214 is expanded.

When the pressure is less than 140 atmospheres, the spaces between the adjacent coils may not be filled with the first and second insulating portions 216a and 216b when the internal pipe 214 is expanded.

Therefore, air gaps may be formed in the spaces between the adjacent coils of the heating unit 213. In addition, the contact portions of the fusing roller 212, the heating unit 213, and the internal pipe 214 may not adhere together, and air gaps may be formed.

These air gaps reduce thermal conduction efficiency, that is, the efficiency of thermal conduction from the heating unit 213 to the fusing roller 212, so that the FPOT is lengthened.

As described above, according to a fusing apparatus of the present invention, since different insulating portions have different thermal conduction efficiencies, the majority of heat generated by a heat generating unit is transmitted to a fusing roller, so that it is possible to increase thermal efficiency.

In addition, since the distance between a heating object and a heated object is reduced, heat can be rapidly transmitted, so that it is possible to shorten the FPOT.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A fusing unit comprising:
a cylindrical fusing roller;
an internal pipe inserted into the fusing roller;
a heating unit disposed between the fusing roller and the internal pipe to surround the internal pipe and generate heat; and
an insulating portion having a first insulating portion disposed between the heating unit and the fusing roller and a second insulating portion disposed between the heating unit and the internal pipe, wherein the first insulating portion has a higher thermal conductivity than the second insulating portion.

2. The fusing unit according to claim 1, wherein the first insulating portion comprises polyimide.

3. The fusing unit according to claim 1, wherein the first insulating portion comprises a liquid crystalline polymer.

4. The fusing unit according to claim 2, wherein the second insulating portion comprises a plurality of mica sheets.

5. The fusing unit according to claim 1, wherein the first insulating portion is comprises a plurality of mica sheets, and the second insulating portion comprises a heat shielding layer contacting the heating unit and the plurality of mica sheets.

6. The fusing unit according to claim 5, wherein the heat shielding layer comprises one of plaster, a ceramic material, and a glass-filled heat-resistance polymer material.

7. The fusing unit according to claim 3, wherein a thickness of the first insulating portion is smaller than that of the second insulating portion.

8. A fusing apparatus of an image forming apparatus having a fusing unit for generating heat and a pressing roller for pressing a paper on which a toner image passing through a contact portion of the fusing unit is transferred toward the fusing unit, the fusing unit comprising:
a cylindrical fusing roller;
an internal pipe inserted into the fusing roller;
a heating unit disposed between the fusing roller and the internal pipe to surround the internal pipe and generate heat; and
an insulating portion having a first insulating portion disposed between the heating unit and the fusing roller and a second insulating portion disposed between the heating unit and the internal pipe, wherein the first insulating portion has a higher thermal conductivity than the second insulating portion.

9. The fusing apparatus according to claim 8, wherein the first insulating portion comprises polyimide.

10. The fusing apparatus according to claim 8, wherein the first insulating portion comprises a liquid crystalline polymer.

11. The fusing apparatus according to claim 9, wherein the second insulating portion comprises a plurality of mica sheets.

12. The fusing apparatus according to claim 8, wherein the first insulating portion is comprises a plurality of mica sheets, and the second insulating portion comprises a heat shielding layer contacting the heating unit and the plurality of mica sheets.

13. The fusing apparatus according to claim 12, wherein the heat shielding layer comprises one of plaster, a ceramic material, and a glass-filled heat-resistance polymer material.

14. The fusing apparatus according to claim 10, wherein a thickness of the first insulating portion is smaller than that of the second insulating portion.

15. A method of manufacturing a fusing roller, comprising the steps of:
surrounding an internal pipe with a second insulating portion;
surrounding the second insulating portion with a heating unit;
surrounding the heating unit with a first insulating portion;
inserting the internal pipe with the second insulating portion, the heating unit, and the first insulating portion into a fusing roller;
expanding the internal pipe into engagement with the fusing roller.

16. The method of manufacturing according to claim 15, further comprising the step of coating an exterior surface of the fusing roller with a release layer.

17. The method of manufacturing according to claim 16, wherein the release layer comprises polytetrafluoroethylene.
